(19) United States
(12) Patent Application Publication
(10) Pub. No.: US 2003/0235203 A1
(43) Pub. Date: Dec. 25, 2003

(54) Extender sublayer device

(76) Inventors: Donald W. Alderrou, Sunnyvale, CA (US); Frederick Buckley III, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/180,269

(22) Filed: Jun. 25, 2002

(51) Int. Cl. H04L 12/413

(52) U.S. Cl. 370/445

(57) ABSTRACT

Disclosed is an extender sublayer device comprising an MII to transmit data between the MII and a plurality of data lanes in an AUI. The extender sublayer device comprises a plurality of internal device pins and a plurality of external device pins where at least some of the external device pins are associated with data lanes in the AUI. Logic may selectively couple the one or more internal circuit pins to one of the external device pins in response to an external control signal.

### BACKGROUND

1. Field

The subject matter disclosed herein relates to backplane communication devices. In particular, the subject matter disclosed herein relates to devices for transmitting data in data link across a backplane.

2. Information

Communications protocols such as Ethernet and Synchronous Optical NETwork/Synchronous Digital Hierarchy (SONET/SDH) have provided techniques for transmitting data in serial data links over a backplane. In particular, versions of the System Packet Interface (SPI) defined in SONET/SDH and 10 Gigabit Ethernet Attachment Unit Interface (XAUI) defined IEEE P802.3ae provide for chip-to-chip communication over printed circuit board traces of up to twenty inches in length or longer.

Traces in a printed circuit board may transmit data between devices in data lanes that are decoded at a destination device. Each data lane typically transmits encoded symbols in a differential signaling pair comprising a signal of a positive signaling polarity and a signal of a negative signaling polarity. The devices transmitting or receiving symbols in a data lane typically comprises a dedicated external device pin for each of the positive and negative signaling polarity signals in the data lane. Accordingly, printed circuit board traces providing such data lanes typically conform to the arrangement of external device pins on transmitting and receiving devices.

### BRIEF DESCRIPTION OF THE FIGURES

Non-limiting and non-exhaustive embodiments of the present invention will be described with reference to the following figures, wherein like reference numerals refer to like parts throughout the various figures unless otherwise specified.

FIG. 1 shows a system to transmit data between two points in data lanes according to an embodiment of the present invention.

FIG. 2 shows an extender sublayer device according to an embodiment of the system shown in FIG. 1.

FIG. 3 illustrates logic to selectively couple external device pins of data lanes to internal circuit pins according to an embodiment of the extender sublayer device shown in FIG. 2.

FIG. 4 illustrates logic to selectively couple internal circuit pins of data lanes to external device pins according to an embodiment of the extender sublayer device shown in FIG. 2.

FIG. 5 illustrates logic to selectively couple external device pins of a differential signaling pair to an internal circuit pin according to an embodiment of the extender sublayer device shown in FIG. 2.

FIG. 6 illustrates logic to selectively couple internal circuit pins of a differential signaling pair to an external device pin according to an embodiment of the extender sublayer device shown in FIG. 2.

### DETAILED DESCRIPTION

Reference throughout this specification to “one embodiment” or “an embodiment” means that a particular feature, structure, or characteristic described in connection with the embodiment is included in at least one embodiment of the present invention. Thus, the appearances of the phrase “in one embodiment” or “an embodiment” in various places throughout this specification are not necessarily all referring to the same embodiment. Furthermore, the particular features, structures, or characteristics may be combined in one or more embodiments.

“Machine-readable” instructions as referred to herein relates to expressions which may be understood by one or more machines for performing one or more logical operations. For example, machine-readable instructions may comprise instructions which are interpretable by a processor compiler for executing one or more operations one or more data objects. However, this is merely an example of machine-readable instructions and embodiments of the present invention are not limited in this respect.

“Machine-readable medium” as referred to herein relates to media capable of maintaining expressions which are perceivable by one or more machines. For example, a machine readable medium may comprise one or more storage devices for storing machine-readable instructions. However, this is merely an example of a machine-readable medium and embodiments of the present invention are not limited in this respect.

“Logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments of the present invention are not limited in this respect.

A “processing system” as discussed herein relates to a combination of hardware and software resources for accomplishing computational tasks. However, this is merely an example of a processing system and embodiments of the present invention are not limited in this respect.

A “data bus” as referred to herein relates to circuitry for transmitting data between devices. For example, a data bus may transmit data between a host processing system and a peripheral device. However, this is merely an example and embodiments of the present invention are not limited in this respect. A “bus transaction” as referred to herein relates to an interaction between devices coupled in a bus structure wherein one device transmits data addressed to the other device through the bus structure.

An “external device pin” as referred to herein relates to electrical contacts protruding from a package of an electronic device. For example, external device pins may electrically couple an electronic component to solder connection in a printed circuit board or to a component socket in a circuit board. However, this is merely an example of external device pins and embodiments of the present invention are not limited in this respect.

An “internal circuit pin” as referred to herein relates to an electrical circuit contact disposed with a package of an electronic circuit. For example, one or more internal circuit pins of an electronic device may be coupled to corresponding external device pins to couple circuits or sub-circuits of the electronic device with other circuitry disposed on a printed circuit board. However, this is merely an example of internal circuit pins and embodiments of the present invention are not limited in these respects.

A “differential pair” as referred to herein relates to a pair of synchronized signals to transmit encoded data to a destination. For example, differential pair may transmit data encoded into symbols to be decoded for data recovery at a destination. Also, each synchronized signal of a differential pair may be associated with a “polarity” that is referenced to an encoding/decoding scheme for the differential pair. Such a polarity scheme may define a positive polarity signal and a negative polarity signal for a differential pair. However, these are merely examples of a differential pair and embodiments of the present invention are not limited in these respects.

A “media independent interface” (MII) as referred to herein relates to an interface to receive data from source or transmit data to a destination in a format which is independent of a particular transmission medium for transmitting the data. For example, a data transceiver may transmit data to a transmission medium in a data transmission format in response to data received at an MII. Also, a data transceiver may provide data to an MII in response to receiving data from a transmission medium in a data transmission format. A “Gigabit MII” (GMII) as referred to herein relates to an MII capable of receiving data from a source or transmitting data to a destination at a data rate of about one gigabit per second. A “10 Gigabit MII” (XGMII) as referred to herein relates to an MII capable of receiving data from a source or transmitting data to a destination at a data rate of about ten gigabits per second. However, these are merely examples of an MII and embodiments of the present invention are not limited in these respects.

A “data link” as referred to herein relates to circuitry to transmit data between devices. A data link may provide point to point communication between two devices in either unidirectionally or bi-directionally. However, this is merely an example of a data link and embodiments of the present invention are not limited in this respect.

A data link may comprise a plurality of “data lanes” where each data lane transmits data from a source to a destination independently of other data lanes. Each data lane in a data link may transmit symbols in a transmission medium which are decoded into data bits at a destination. The decoded bits from the data lanes may then be combined. However, this is merely an example of data lanes that may be used to transmit data in a data link and embodiments of the present invention are not limited in these respects.

An “attachment unit interface” (AUI) as referred to herein relates to a physical medium capable of transmitting data between an attachment to a transmission medium of data network and data terminal equipment. An “Extended Attachment Unit Interface” as referred to herein relates to a data link capable of transmitting data between an MII and data transceiver. A 10 Gigabit Extended Attachment Unit Interface” (XAUI) as referred to herein relates to an extended attachment unit interface capable of transmitting data between an XGMII and a data transceiver. Other Extended Attachment Unit Interfaces may be defined for higher data rates such as 40 or 100 gigabits per second.

An “extender sublayer device” as referred to herein relates to a device to extend a data link over a backplane. For example, an extender sublayer device may comprise an MII to transmit data between data lanes in an AUI and a data transceiver. However, this is merely an example of an extender sublayer device and embodiments of the present invention are not limited in these respects.

An “external control signal” as referred to herein relates to a signal provided a device to determine the behavior of the device in response to other signals or data. An external control signal may be provided as one or more voltages on external device pins or a message transmitted on a multiplexed data bus. However, these are merely examples of an external control signal and embodiments of the present invention are not limited in these respects.

Briefly, an embodiment of the present invention relates to an extender sublayer device comprising an MII to transmit data between the MII and a plurality of data lanes in an AUI. The extender sublayer device may comprise a plurality of internal device pins and a plurality of external device pins where at least some of the external device pins associated with data lanes in the AUI. The extender sublayer device may further comprise logic to selectively couple the one or more internal circuit pins to one of the external device pins in response to an external control signal. However, this is merely an example embodiment and other embodiments of the present invention are not limited in these respects.

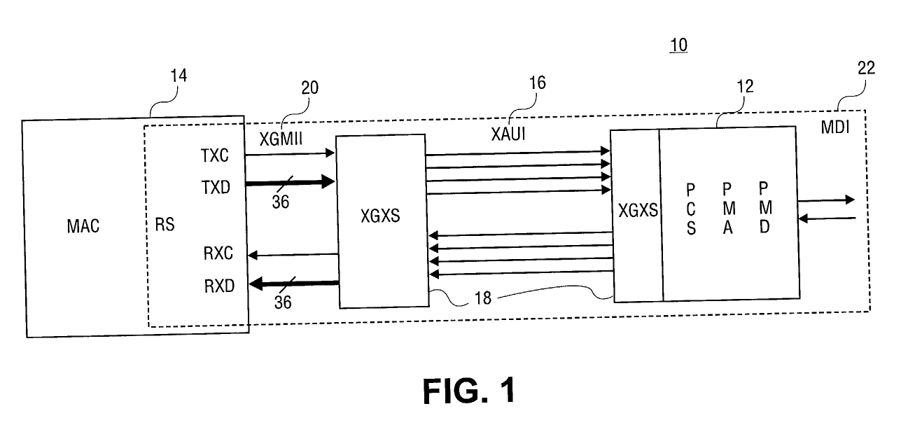

FIG. 1 shows a system 10 to transmit data between two points in data lanes according to an embodiment of the present invention. A data transceiver 12 may transmit data to or receive data from a transmission medium through a media dependent interface (MDI) 22. For example, the data transceiver 12 may comprise a physical medium attachment (PMA) and physical medium dependent (PMD) and physical coding sublayer (PCS) devices to communicate with an optical transmission medium according to IEEE P802.3ae, clauses 48 through 51.

The system 10 may also comprise a media access control (MAC) device 14 to communicate with the data transceiver 12 through a media independent interface (MII) such as a 10 Gigabit MII (XGMII) 20 formed according to IEEE P802.3ae, clause 46. The MAC device 14 may also be coupled to any one of several types of input/output systems such as, for example, a multiplexed data bus or a switch fabric. However these are merely examples of how a MAC device may be integrated with a communication platform and embodiments of the present invention are not limited in these respects.

The MAC device 14 and data transceiver 12 may be coupled to the data transceiver 12 by a serial data link such as 10 Gigabit Attachment Unit Interface (XAUI) 16 formed according to IEEE standard 802.3ae, clauses 47 and 48. XAUI 16 may be coupled between first and second XGMII extender sublayer (XGXS) circuits 18. The first and second XGXS circuits 18 may be coupled on a printed circuit board by traces extending up to approximately 50 cm. in a backplane configuration. However, this is merely an example of how a MAC device may be coupled to a data transceiver over a data link and embodiments of the present invention are not limited in these respects.

In the illustrated embodiment, the XGXS circuits 18 may transmit data across the XAUI 16 in multiple data lanes where each data lane transmits data in a particular direction either toward or away from the data transceiver 12. In the illustrated embodiment, data transmitted in different lanes in a time period to an XGXS circuit 18 may be recombined. Accordingly, the XGXS circuits 18 may deskew data transmitted on different data lanes to maintain proper alignment of the data received on the different data lanes.

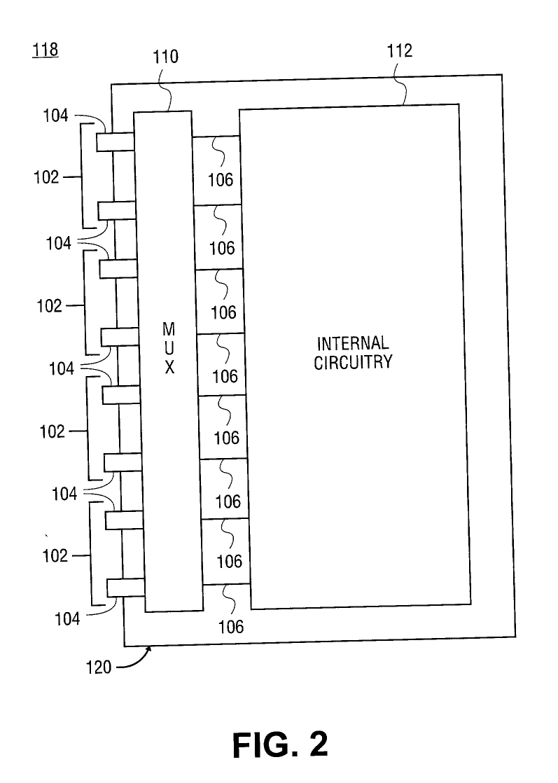

FIG. 2 shows an extender sublayer device 118 according to an embodiment of the system shown in FIG. 1. The extender sublayer device 118 comprises a device package 120 and a plurality of external device pins 104 protruding from the device package for contact with external circuitry. For example, the external device pins 104 may be configured in a ball grid array or other configuration for mating with a device socket disposed on a printed circuit board. In other embodiments, the external device pins 104 may be adapted for surface mounting in a printed circuit board. However, these are merely examples of how external device pins may be coupled to external circuitry on a printed circuit board and embodiments of the present invention are not limited in these respects.

FIG. 2 shows four data lanes 102 that may be used for either transmitting or receiving data from an attachment unit interface. Data lanes 102 may each be coupled to a corresponding pair of external device pins 104. It should be understood, however, that the extender sublayer device 118 may comprise a first set of external device pins for transmitting data in data lanes through the AUI and a second set of external device pins for receiving data in data lanes through the AUI. In an embodiment where the data lanes 102 are provided in a XAUI link, for example, the extender sublayer device 118 may comprise eight external device pins for coupling to four transmit data lanes and eight external device pins for coupling to four receive data lanes.

Internal circuitry 112 may comprise an 8b/10b encoder or decoder (e.g., 8b/10b codec), as described in IEEE standard 802.3-2000, clause 36, providing a plurality of internal circuit pins 106 coupled to a multiplexer 110. Each of the data lanes 102 may provide a corresponding differential signal pair on two external device pins 104 to transmit or receive encoded data symbols. Each such differential signal pair may correspond with a differential signaling polarity where one signal provides a positive polarity signal and another signal provides a negative polarity signal. The multiplexer 110 may selectively couple individual external device pins 104 with internal circuit pins 106 in response to an external control signal 108. For example, the multiplexer 110 may selectively couple any pair of external device pins 104 of a corresponding data lane 102 with any pair of internal circuit pins 106. Also, for any pair of external device pins 104 corresponding with a particular differential signaling pair, the multiplexer 110 may selectively couple a corresponding pair of internal circuit pins 106 according to one of two differential signaling polarities. However, these are merely examples of selectively coupling internal circuit pins to external device pins in response to an external control signal and embodiments of the present invention are not limited in these respects.

According to an embodiment, the multiplexer 110, internal circuit pins 106 and internal circuitry 112 may be formed in a single semiconductor device coupled to the external device pins 104. The multiplexer 110 may comprise electronic switching logic to selectively couple the internal circuit pins 106 to the external device pins 104. However, this is merely an example of how internal circuit pins may be selectively coupled to external device pins and embodiments of the present invention are not limited in this respect.

In the presently illustrated embodiment, the external device pins 104 are shown directly coupled to the multiplexer 108. In other embodiments, external device pins may be coupled to such a multiplexer through other circuitry such as, for example, input or output buffers (not shown), clock and data recovery circuitry, data synchronization circuitry or other intermediary circuitry which may process signals received from or transmitted to external device pins. Again, these are merely examples of how external device pins may be coupled to a multiplexer (either directly or through intermediary circuitry) and embodiments of the present invention are not limited in these respects.

The internal circuitry 112 may also provide an MII (not shown) to other external device pins (not shown) or another integrated device (not shown) such as a MAC device or media dependent data transceiver. However, these are merely examples of how an extender sublayer device may provide an MII and embodiments of the present invention are not limited in these respects.

According to an embodiment, the extender sublayer device 118 may comprise a Management Data Input/Output (MDIO) interface (not shown) provided according to IEEE P802.3ae, clauses 22 and/or 45. In particular, the extender sublayer device 118 may comprise an MDIO interface to provide the external signal 108 on one or more registers defined in the MDIO interface. According to embodiment, the extender sublayer circuit 118 may be coupled to a processing system (not shown) by a data bus (not shown) where the processing system hosts a management entity or configuration entity to write to the MDIO interface. For example, the processing system may execute firmware in response to an event (e.g., a processor reset event) to write data in registers of the MDIO interface providing the external control signal 108 among other control signals to configure the extender sublayer device 118. However, this is merely an example of how an external control signal may be provided to an extender sublayer device and embodiments of the present invention are not limited in these respects.

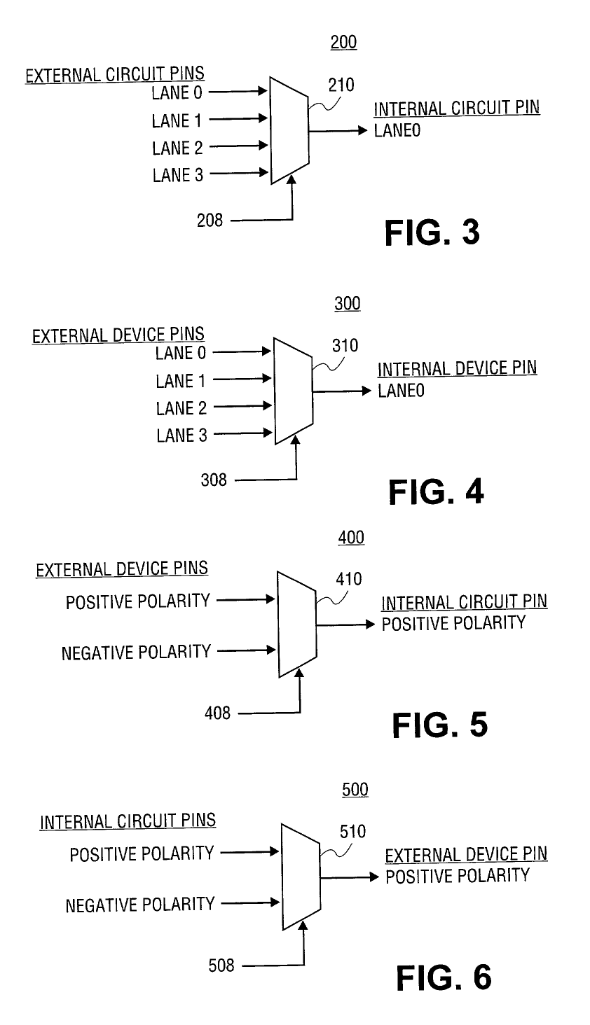

FIG. 3 illustrates logic to selectively couple external device pins of data lanes to internal circuit pins according to an embodiment of the extender sublayer circuit 118 shown in FIG. 2. An external control signal 208 may determine which of a plurality of data lanes (at corresponding external device pins) is to be coupled to one or more internal circuit pins. In response to the external control signal 208, a multiplexer 210 may couple the external data pins of any data lane (e.g., two external data pins for data lanes provided by a differential signaling pair) to one or more internal circuit pins corresponding to a data lane.

FIG. 4 illustrates logic to selectively couple internal circuit pins of data lanes to external device pins according to an embodiment of the extender sublayer circuit 118 shown in FIG. 2. An external control signal 308 may determine which of a plurality of data lanes (at corresponding internal circuit pins) is to be coupled to one or more external device pins. In response to the external control signal 308, a multiplexer 310 may couple the external data pins of any data lane (e.g., two internal circuit pins for data lanes provided by a differential signaling pair) to one or more external device pins corresponding to a data lane.

FIGS. 3 and 4 illustrate embodiments for selectively coupling external device pins of a data lane to internal circuit pins of a data lane. For any particular data lane using differential signaling, FIG. 5 illustrates logic to selectively couple one of two external device pins of a differential signaling pair to an internal circuit pin according to an embodiment of the extender sublayer circuit 118 shown in FIG. 2. Such a differential signaling pair may provide a positive polarity signal on a first external device pin and a negative polarity signal on a second external device pin. In response to an external control signal 408, a multiplexer 410 may selectively couple an internal circuit pin to the external device pin of either the positive polarity signal or the negative polarity signal.

Similarly, FIG. 6 illustrates logic to selectively couple internal circuit pins of a differential signaling pair to an external device pin according to an embodiment of the extender sublayer circuit 118 shown in FIG. 2. Such a differential signaling pair may provide a positive polarity signal on a first internal circuit pin and negative polarity signal on a second internal circuit pin. In response to an external control signal 508, a multiplexer 510 may selectively couple an external device pin to the internal circuit pin of either the positive polarity signal or the negative polarity signal.

FIGS. 3 and 4 illustrate logic to selectively couple external device pins and internal circuit pins in a first dimension according to data lanes. FIGS. 5 and 6 illustrate logic to selectively couple external device pins and internal circuit pins of a data lane in a second dimension according to signal polarity. It should be understood, however, that the extender sublayer device 118 may selectively couple internal circuit pins and external device pins in either or both dimensions. That is, in one embodiment, the extender sublayer device 118 may selectively couple external device pins and internal circuit pins based upon data lane, signal polarity, or both in response to the external control signal 108.

While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein. Therefore, it is intended that the present invention not be limited to the particular embodiments disclosed, but that the invention include all embodiments falling within the scope of the appended claims.

What is claimed is:

1. An extender sublayer device comprising:
a media independent interface (MII) coupled to one or more internal circuit pins;
a plurality of external device pins adapted to be coupled to an attachment unit interface comprising a plurality of data lanes, each external device pin being associated with a data lane; and
logic to selectively couple the one or more internal circuit pins to one of the external device pins in response to an external control signal.

2. The extender sublayer device of claim 1, wherein at least one of the data lanes is associated with a differential signaling pair coupled to corresponding external device pins, and wherein the extender sublayer device further comprises logic to selectively couple at least one of the internal circuit pins to either a positive polarity signal or negative polarity signal of the differential signaling pair in response to the external control signal.

3. The extender sublayer device of claim 1, the extender sublayer device further comprising logic to selectively couple the one or more internal circuit pins to one of the data lanes in response to the external control signal.

4. The extender sublayer device of claim 3, wherein each of the data lanes is associated with a differential signaling pair coupled to corresponding external device pins, and wherein the extender sublayer device further comprises logic to selectively couple at least one of the internal circuit pins to either a positive polarity signal or negative polarity signal of the differential signaling pair in response to the external control signal.

5. The extender sublayer device of claim 1, wherein the MII comprises a 10 gigabit per second MII.

6. The extender sublayer device of claim 1, wherein the extender sublayer device further comprises a Management Data Input/Output interface to receive the external control signal.

7. A system comprising:
a media access controller (MAC) device; and
an extender sublayer device comprising:
a media independent interface (MII) coupled to the MAC device and one or more internal circuit pins;
a plurality of external device pins adapted to be coupled to an attachment unit interface comprising a plurality of data lanes, each external device pin being associated with a data lane; and
logic to selectively couple the one or more internal circuit pins to one of the external device pins in response to an external control signal.

8. The system of claim 7, wherein the system further comprises a multiplexed data bus coupled to the MAC device.

9. The system of claim 7, wherein the system further comprises a switch fabric coupled to the MAC device.

10. The system of claim 7, wherein at least one of the data lanes is associated with a differential signaling pair coupled to corresponding external device pins, and wherein the extender sublayer device further comprises logic to selectively couple at least one of the internal circuit pins to either a positive polarity signal or negative polarity signal of the differential signaling pair in response to the external control signal.

11. The system of claim 7, wherein the extender sublayer device further comprising logic to selectively couple the one or more internal circuit pins to one of the data lanes in response to the external control signal.

12. The system of claim 11, wherein each of the data lanes is associated with a differential signaling pair coupled to corresponding external device pins, and wherein the extender sublayer device further comprises logic to selectively couple at least one of the internal circuit pins to either a positive polarity signal or negative polarity signal of the differential signaling pair in response to the external control signal.

13. The system of claim 7, wherein the MII comprises a 10 gigabit per second MII.

14. The system of claim 7, wherein the extender sublayer device further comprises a Management Data Input/Output interface to receive the external control signal.

15. A system comprising:
a data transceiver adapted to be coupled to an optical transmission medium;
an attachment unit interface (AUI) comprising a plurality of data lanes;
a first extender sublayer circuit coupled to the data transceiver at a first media independent interface (MII) and the AUI; and
a second extender sublayer circuit coupled to a second MII and the AUI,
wherein at least one of the first and second extender sublayer circuits comprises:
a plurality of external device pins adapted to be coupled to the AUI, each external device pin being associated with a data lane; and
logic to selectively couple the one or more internal circuit pins to one of the external device pins in response to an external control signal.

16. The system of claim 15, wherein at least one of the data lanes is associated with a differential signaling pair coupled to corresponding external device pins, and wherein the at least one extender sublayer device further comprises logic to selectively couple at least one of the internal circuit pins to either a positive polarity signal or negative polarity signal of the differential signaling pair in response to the external control signal.

17. The system of claim 15, wherein the at least one extender sublayer device further comprises logic to selectively couple the one or more internal circuit pins to one of the data lanes in response to the external control signal.

18. The system of claim 17, wherein each of the data lanes is associated with a differential signaling pair coupled to corresponding external device pins, and wherein the at least one extender sublayer device further comprises logic to selectively couple at least one of the internal circuit pins to either a positive polarity signal or negative polarity signal of the differential signaling pair in response to the external control signal.

19. The system of claim 15, wherein each MII comprises a 10 gigabit per second MII.

20. The system of claim 15, wherein the at least one extender sublayer device further comprises a Management Data Input/Output interface to receive the external control signal.

21. A method comprising:
coupling a plurality of external device pins of an extender sublayer device to a printed circuit board to provide an attachment unit interface, the extender sublayer device comprising a media independent interface (MII);
providing a control signal external to the extender sublayer device; and
selectively coupling one or more internal circuit pins of the extender sublayer device to one of the external device pins in response to the control signal.

22. The method of claim 21, wherein the attachment unit interface comprises a plurality data lanes, at least one data lane being associated with a differential signaling pair coupled to corresponding external device pins, and wherein method further comprises selectively coupling at least one of the internal circuit pins to either a positive polarity signal or negative polarity signal of the differential signaling pair in response to the control signal.

23. The method of claim 21, wherein the attachment unit interface comprises a plurality data lanes, and wherein the method further comprises selectively coupling the one or more internal circuit pins to one of the data lanes in response to the control signal.

24. The method of claim 23, wherein each of the data lanes is associated with a differential signaling pair coupled to corresponding external device pins, and wherein the extender sublayer device further comprises logic to selectively couple at least one of the internal circuit pins to either a positive polarity signal or negative polarity signal of the differential signaling pair in response to the control signal.

25. The method of claim 21, wherein the MII comprises a 10 gigabit per second MII.

26. The method of claim 21, the method further comprising receiving the external control signal at a Management Data Input/Output interface.
